(19) United States
(12) Patent Application Publication
(10) Pub. No.: US 2016/0180741 A1
(43) Pub. Date: Jun. 23, 2016

(54) PRONUNCIATION LEARNING DEVICE, PRONUNCIATION LEARNING METHOD AND RECORDING MEDIUM STORING CONTROL PROGRAM FOR PRONUNCIATION LEARNING

(71) Applicant: CASIO COMPUTER CO., LTD., Tokyo (JP)

(72) Inventor: Atsushi YAMAMOTO, Tokyo (JP)

(73) Assignee: CASIO COMPUTER CO., LTD., Tokyo (JP)

(21) Appl. No.: 14/841,565

(22) Filed: Aug. 31, 2015

(30) Foreign Application Priority Data
Sep. 16, 2014 (JP) 2014-188131

(51) Int. Cl. G09B 19/06; G09B 5/06

(52) U.S. Cl. CPC G09B 19/06; G09B 5/06

(57) ABSTRACT

A pronunciation learning device includes: an example sentence text storage area in which a plurality of example sentence texts is stored; an example sentence pronunciation storage area in which each of the example sentence texts stored in the example sentence text storage area is associated with pronunciation data and stored as a pronunciation-associated example sentence; a pronunciation learning processing control program configured to vocally output pronunciation data of a word specified by a user's operation; and a pronunciation-associated example sentence registration area in which a pronunciation-associated example sentence including the pronunciation data of the word is extracted from the example sentence pronunciation storage area and is registered, and the pronunciation learning processing control program reads pronunciation data of any one of registered pronunciation-associated example sentences, from the example sentence pronunciation storage area, and vocally outputs the read pronunciation data.

### BACKGROUND

1. Technical Field

The present invention relates to a pronunciation learning device and a control program thereof. More particularly, the present invention relates to a pronunciation learning device which has a function which allows a user to efficiently learn pronunciations, and a control program thereof.

2. Related Art

Recent electronic dictionaries have, for example, a function of outputting a pronunciation of a specific example sentence as disclosed in JP 2013-37251 A or a function of searching for a word in an example sentence, vocally outputting the example sentence and displaying a translation for learning a pronunciation of words as disclosed in JP 2006-268501 A. Therefore, some electronic dictionaries are used not only for dictionaries but also for pronunciation learning devices.

### SUMMARY

However, such a conventional pronunciation learning device has the following problem.

That is, as described above, the conventional pronunciation learning device can not only output pronunciations of words but also output pronunciations of example sentences including the words. However, such a conventional pronunciation learning device cannot associate and provide pronunciations of words and a pronunciation of an example sentence including these words.

Hence, when learning pronunciations of words included in an example sentence vocally output from a conventional pronunciation learning device, a user needs to operate a pronunciation learning device to output a pronunciation per individual word included this example sentence.

Therefore, even when the user wants to learn both of pronunciations of new words and a pronunciation of an example sentence including these words, a conventional pronunciation learning device does not have a function of associating pronunciations of words and a pronunciation of an example sentence including these words. Therefore, since there is a problem that it is bothersome for a user to operate the pronunciation learning device to output a pronunciation per individual word included in the example sentence, the user cannot efficiently learn the pronunciations.

The present invention has been made in light of such a situation. It is therefore an object of the present invention to provide a pronunciation learning device which can associate and provide pronunciations of words and a pronunciation of an example sentence including these words and, consequently, provide a function of enabling a user to efficiently learn pronunciations.

A pronunciation learning device according to the present invention includes: an example sentence text storage unit configured to store a plurality of example sentence texts each of which includes a plurality of words; an example sentence pronunciation storage unit configured to associate and store each of the example sentence texts stored in the example sentence text storage unit with pronunciation data as a pronunciation-associated example sentence; a word pronunciation output unit configured to vocally output pronunciation data of a word specified by a user's operation; a pronunciation-associated example sentence registering unit configured to extract from the example sentence pronunciation storage unit a pronunciation-associated example sentence including the pronunciation data of the word, and to register the extracted pronunciation-associated example sentence; and an example sentence pronunciation output unit configured to read from the example sentence pronunciation storage unit pronunciation data of any one of the pronunciation-associated example sentences registered in the pronunciation-associated example sentence registering unit, and to vocally output the read pronunciation data.

The present invention can realize a pronunciation learning device which can associate and provide pronunciations of words and a pronunciation of an example sentence including these words, and which allows a user to efficiently learn pronunciations.

### BRIEF DESCRIPTION OF DRAWINGS

FIG. 1 is a block diagram showing a configuration of an electronic circuit of a pronunciation learning device according to a first embodiment of the present invention;

FIG. 2 is a front view showing an external appearance configuration in case where the pronunciation learning device according to the first embodiment of the present invention is realized as an electronic dictionary device;

FIG. 3 is a front view showing an external appearance configuration in case where the pronunciation learning device according to the first embodiment of the present invention is realized as a tablet terminal;

FIG. 4 is a flowchart showing processing (part 1) of the pronunciation learning device according to the first embodiment of the present invention;

FIG. 5 is a flowchart showing processing (part 2) of the pronunciation learning device according to the first embodiment of the present invention;

FIG. 6 is a flowchart showing processing (part 3) of the pronunciation learning device according to the first embodiment of the present invention;

FIG. 7 is a flowchart showing processing (part 4) of the pronunciation learning device according to the first embodiment of the present invention;

FIG. 8 is a flowchart showing processing (part 5) of the pronunciation learning device according to the first embodiment of the present invention;

FIG. 9 is a view showing an example (part 1) of a display screen of the pronunciation learning device according to the first embodiment of the present invention;

FIG. 10 is a view showing an example (part 2) of the display screen of the pronunciation learning device according to the first embodiment of the present invention;

FIG. 11 is a view showing an example (part 3) of the display screen of the pronunciation learning device according to the first embodiment of the present invention;

FIG. 12 is a view showing an example (part 4) of the display screen of the pronunciation learning device according to the first embodiment of the present invention;

FIG. 13 is a view showing an example (part 5) of the display screen of the pronunciation learning device according to the first embodiment of the present invention;

FIG. 14 is a view showing an example (part 6) of the display screen of the pronunciation learning device according to the first embodiment of the present invention; and

FIG. 15 is a conceptual diagram showing a configuration example of a pronunciation learning device according to a second embodiment of the present invention.

### DETAILED DESCRIPTION

Each embodiment of the present invention will be described below with reference to the drawings.

### First Embodiment

A pronunciation learning device according to a first embodiment of the present invention will be described.

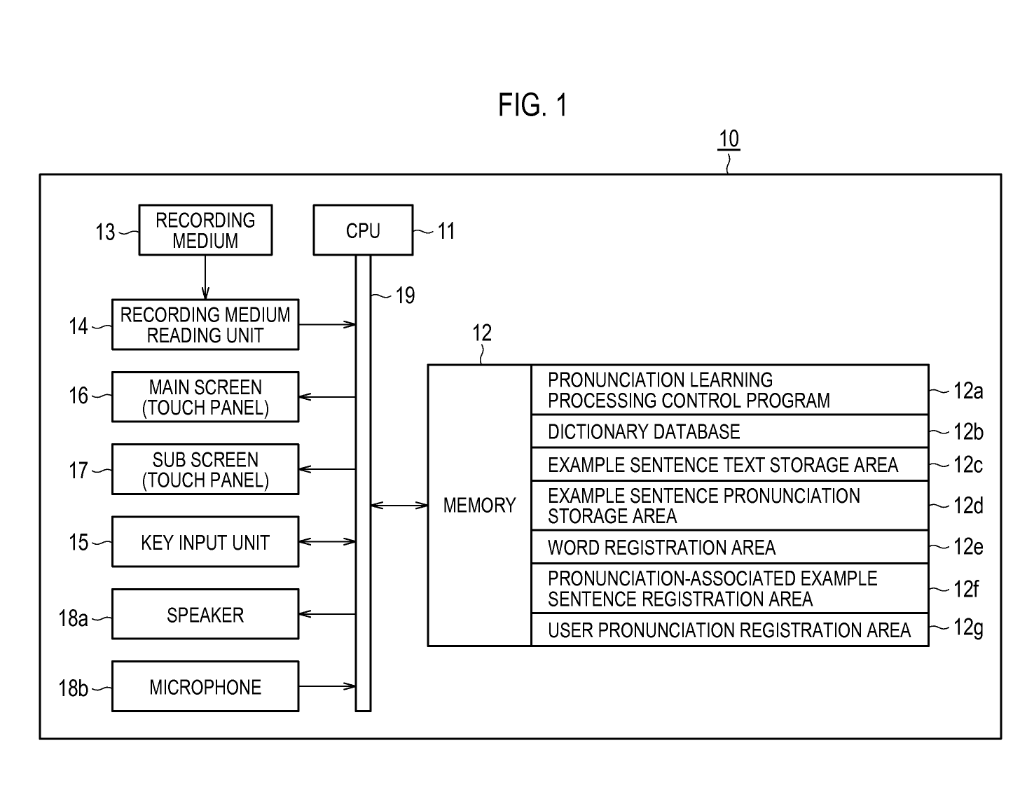

FIG. 1 is a block diagram showing an electronic circuit of a pronunciation learning device 10 according to the first embodiment of the present invention.

This pronunciation learning device 10 is a device which is preferable to learn pronunciations of foreign languages in particular, and includes a CPU 11, a memory 12, a recording medium reading unit 14, a key input unit 15, a main screen 16, a sub screen 17, a speaker 18a and a microphone 18b which are connected with each other through a communication bus 19.

The CPU 11 controls an operation of the pronunciation learning device 10 according to a pronunciation learning processing control program 12a stored in advance in the memory 12, the pronunciation learning processing control program 12a read to the memory 12 from an external recording medium 13 such as a ROM card through the recording medium reading unit 14, or the pronunciation learning processing control program 12a downloaded from a web server (a program server in this case) on the Internet and read to the memory 12.

The pronunciation learning processing control program 12a also includes a communication program for performing data communication with each web server on the Internet or a user PC (Personal Computer) externally connected to the pronunciation learning device 10. Further, the pronunciation learning processing control program 12a is activated according to an input signal corresponding to a user's operation from the key input unit 15, an input signal corresponding to a user's operation from the main screen 16 or the sub screen 17 having a touch panel color display function, a communication signal for the web server on the externally connected Internet or a connection communication signal for the recording medium 13 such as an EEPROM, a RAM or a ROM externally connected through the recording medium reading unit 14.

The memory 12 includes a dictionary database 12b, an example sentence text storage area 12c, an example sentence pronunciation storage area 12d, a word registration area 12e, a pronunciation-associated example sentence registration area 12f, and a user pronunciation registration area 12g.

In the dictionary database 12b, dictionaries (an English-Japanese dictionary, a Japanese-English dictionary, an English-English dictionary, a Chinese-Japanese dictionary, a Japanese-Chinese dictionary, Chinese phrases and a Chinese-Chinese dictionary) and phrases of learning target foreign languages such as English or Chinese are stored. A dictionary stores pieces of general dictionary information such as parts of speech, an etymology, a spelling, conjugated forms, a phonetic symbol, synonyms, word pronunciation data, meanings, a usage, example sentences, and an example sentence pronunciation data per word. As phrases, information such as example sentences, meanings and pronunciations are stored per situation such as a travel, business, life and cooking. In addition, the numbers of dictionaries and phrases are not limited to singular forms. The dictionary database 12b may store a plurality of dictionaries of similar types like a plurality of English-Japanese dictionaries.

The example sentence text storage area 12c is a storage area in which example sentence texts are extracted from the dictionaries and the phrases stored in the dictionary database 12b under control of the pronunciation learning processing control program 12a, and are stored together with names of sources (e.g. English-Japanese Dictionary A). In the other words, the example sentence text storage area 12c configures an example sentence text storage unit configured to store a plurality of example sentence texts each of which includes a plurality of words.

The example sentence pronunciation storage area 12d is a storage area in which each example sentence text stored in the example sentence text storage area 12c is associated with the pronunciation data and stored as a pronunciation-associated example sentence under control of the pronunciation learning processing control program 12a. In the other words, the example sentence pronunciation storage area 12d configures an example sentence pronunciation storage unit configured to associate and store each of the example sentence texts stored in the example sentence text storage area 12c with pronunciation data as a pronunciation-associated example sentence.

The word registration area 12e is a registration area in which a word of pronunciation data vocally output from the speaker 18a is registered under control of the pronunciation learning processing control program 12a. In addition, there are also words registered in advance in the word registration area 12e. The words registered in advance are basic words for which the user does not need to practice, and correspond to, for example, “I”, “to” and “the” in case of English. In the other words, the word registration area 12e configures a word registering unit configured to register the word corresponding to the pronunciation data vocally output by the speaker 18a. And, the speaker 18a configures a word pronunciation output unit configured to vocally output pronunciation data of a word specified by a user's operation.

The pronunciation-associated example sentence registration area 12f is a registration area in which a pronunciation-associated example sentence including the pronunciation data of the word registered in the word registration area 12e is extracted from the example sentence pronunciation storage area 12d and the extracted pronunciation-associated example sentence is registered under control of the pronunciation learning processing control program 12a. One of items of pronunciation data of pronunciation-associated example sentences registered in the pronunciation-associated example sentence registration area 12f is read from the example sentence pronunciation storage area 12d and is vocally output from the speaker 18a under control of the pronunciation learning processing control program 12a performed by a user's operation. In the other words, the pronunciation-associated example sentence registration area 12f configures a pronunciation-associated example sentence registering unit configured to extract from the example sentence pronunciation storage area 12d a pronunciation-associated example sentence including the pronunciation data of the word registered in the word registering area 12e, and to register the extracted pronunciation-associated example sentence. And, the speaker 18a also configures an example sentence pronunciation output unit configured to read from the example sentence pronunciation storage area 12d pronunciation data of any one of the pronunciation-associated example sentences registered in the pronunciation-associated example sentence registering area 12f, and to vocally output the read pronunciation data.

The user pronunciation registration area 12g is a storage area in which pronunciation data obtained by the microphone 18b and pronounced by the user is stored.

The example sentence text storage area 12c, the example sentence pronunciation storage area 12d, the word registration area 12e and the pronunciation-associated example sentence registration area 12f are preferably provided per language.

The pronunciation learning processing control program 12a which is applied to the pronunciation learning device 10 according to the first embodiment of the present invention controls an operation performed by a conventional electronic dictionary or pronunciation learning device, and, the following operation by using these dictionary database 12b, example sentence text storage area 12c, the example sentence pronunciation storage area 12d, the word registration area 12e and the pronunciation-associated example sentence registration area 12f.

The pronunciation learning processing control program 12a causes a new example sentence text to be stored in the example sentence text storage area 12c.

The pronunciation learning processing control program 12a causes each example sentence text stored in the example sentence text storage area 12c to be associated as a pronunciation-associated example sentence with pronunciation data and stored in the example sentence pronunciation storage area 12d.

The pronunciation learning processing control program 12a causes the speaker 18a to vocally output pronunciation data of a word specified by a user's operation by using the key input unit 15.

The word corresponding to pronunciation data vocally output from the speaker 18a is registered in the word registration area 12e.

The pronunciation learning processing control program 12a causes a pronunciation-associated example sentence including the pronunciation data of the word registered in the word registration area 12e to be extracted from the example sentence pronunciation storage area 12d, and causes the extracted pronunciation-associated example sentence to be registered in the pronunciation-associated example sentence registration area 12f.

The pronunciation learning processing control program 12a causes pronunciation data specified by a user's operation among pronunciation-associated example sentences registered in the pronunciation-associated example sentence registration area 12f, to be read from the example sentence pronunciation storage area 12d, and causes the speaker 18a to vocally output the pronunciation data.

The word specified by the user's operation using the key input unit 15 and corresponding to the pronunciation data vocally output from the speaker 18a is registered in the word registration area 12e.

In response to registration of the word in the word registration area 12e, the pronunciation learning processing control program 12a causes the main screen 16 or the sub screen 17 to display a list of the pronunciation-associated example sentences registered in the pronunciation-associated example sentence registration area 12f.

The pronunciation learning processing control program 12a causes the main screen 16 or the sub screen 17 to display a list of words registered in the word registration area 12e.

The pronunciation learning processing control program 12a causes a pronunciation-associated example sentence including the pronunciation data of the word specified and selected by the user among a list of the words displayed on the main screen 16 or the sub screen 17, to be extracted from the example sentence pronunciation storage area 12d, and causes the main screen 16 or the sub screen 17 to display a list of the pronunciation-associated example sentences.

When causing the main screen 16 or the sub screen 17 to display the list of the pronunciation-associated example sentences, the pronunciation learning processing control program 12a causes the main screen 16 or the sub screen 17 to display the pronunciation-associated example sentences including the word whose pronunciation changes in a state where the word is identifiable among other words.

In addition, the pronunciation learning processing control program 12a also controls an operation performed by the conventional electronic device or pronunciation learning device, in addition to these operations. However, the operation in these conventional techniques will not be described in this description.

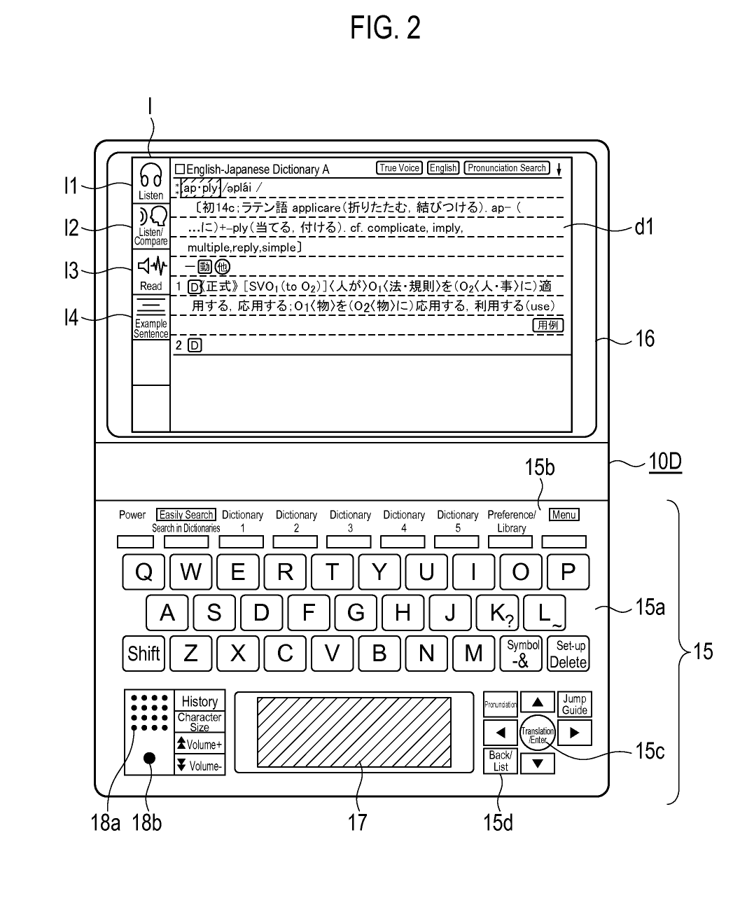

FIG. 2 is a front view showing an external appearance configuration in case where the pronunciation learning device 10 according to the first embodiment of the present invention is realized as an electronic dictionary device 10D.

In case of the electronic dictionary device 10D in FIG. 2, the CPU 11, the memory 12 and the recording medium reading unit 14 are built in a lower stage side of a device main body which is opened and closed, the key input unit 15, the sub screen 17, the speaker 18a and the microphone 18b are provided, and the main screen 16 is provided at an upper stage side.

The key input unit 15 further includes character input keys 15a, various dictionary specifying keys 15b, a [Translation/Enter] key 15c and a [Back/List] key 15d.

The main screen 16 of the electronic dictionary device 10D in FIG. 2 shows an example where the user specifies the English-Japanese dictionary (e.g. English-Japanese Dictionary A) by using the dictionary specifying key 15b, and, when a search word “apply” is input from the key input unit 15, explanation information d1 (e.g. parts of speech, an etymology, a spelling, conjugated forms, a phonetic symbol, synonyms, meanings, a usage, and example sentences) of the search word obtained from English-Japanese dictionary (e.g. Genius English-Japanese Dictionary) data stored in the dictionary database 12b is displayed.

On a leftmost side of the main screen 16, various function selection icons I are displayed vertically in a row. In the example in FIG. 2, a “Listen” icon I1, a “Listen/Compare” icon I2, a “Read” icon I3 and an “Example Sentence” icon I4 are displayed as examples of these function selection icons I. However, arbitrary icons can also be additionally provided. When the user touches one of these icons I1 to I4 by the finger or a touch pen, the pronunciation learning processing control program 12a is activated to execute predetermined processing.

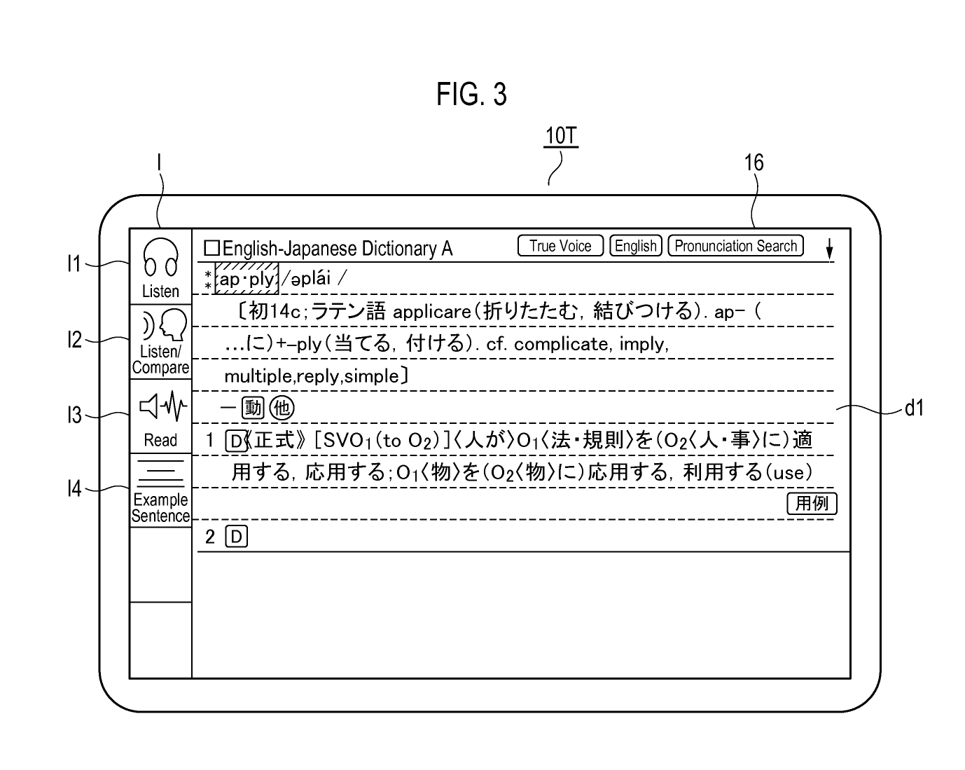

FIG. 3 is a front view showing an external appearance configuration in case where the pronunciation learning device 10 according to the first embodiment of the present invention is realized as a tablet terminal 10T.

In case of the tablet terminal 10T in FIG. 3, the CPU 11, the memory 12 and the recording medium reading unit 14 are built in a terminal main body, and various icons and a software keyboard displayed on the main screen 16 when necessary function as the key input unit 15. Consequently, it is possible to realize the same function as the electronic dictionary device 10D shown in FIG. 2.

The pronunciation learning device 10 according to the first embodiment of the present invention can be realized as not only a mobile device for an electronic dictionary shown in FIG. 2 (electronic dictionary device 10D) and the tablet terminal 10T having the dictionary function shown in FIG. 3, but also so-called electronic devices such as mobile telephones, electronic books and mobile game machines.

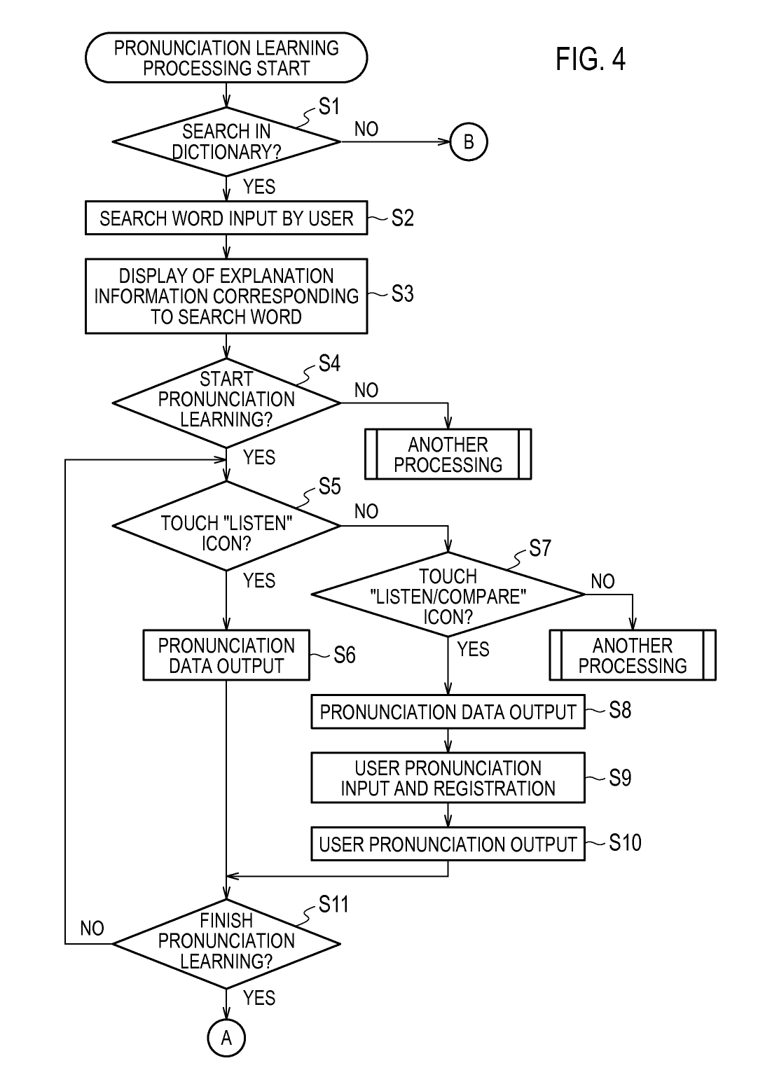

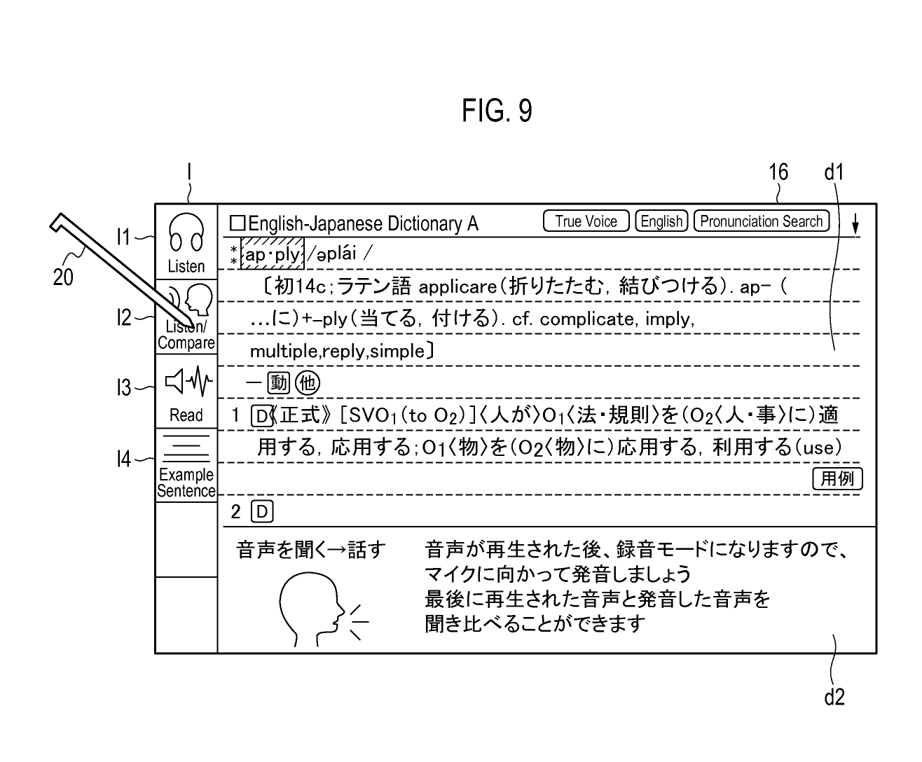

Next, an example of various types of processing performed when the pronunciation learning processing control program 12a operates will be described with reference to flowcharts shown in FIGS. 4 to 8 and display screen examples shown in FIGS. 9 to 14.

As shown in the flowchart in FIG. 4, when the pronunciation learning device 10 according to the first embodiment of the present invention is used to search in a dictionary (S1: Yes), the user specifies the English-Japanese dictionary (e.g. English-Japanese Dictionary A) by using the dictionary specifying key 15b, and inputs a search word “apply” by using the key input unit 15 (S2).

Then, the search word (“apply”) is searched in the specified dictionary (e.g. English-Japanese Dictionary A) stored in the dictionary database 12b, and the explanation information d1 of the search word (e.g. parts of speech, an etymology, a spelling, conjugated forms, a phonetic symbol, synonyms, meanings, a usage, and example sentences) is displayed on the main screen 16 (S3).

Further, when the user wants to learn a pronunciation of this search word (S4: Yes), the user touches the “Listen” icon I1 or the “Listen/Compare” icon I2 by the finger or the touch pen (S5 or S7). Meanwhile, when the user does not want to learn the pronunciation of the search word (S4: No), for example, the processing moves to another processing (which will not be described in detail) of using the pronunciation learning device 10 according to the present embodiment as a normal electronic dictionary.

When the user touches the “Listen” icon I1 (S5: YES), the “Listen” icon I1 is displayed by way of monochrome inversion (not shown) and is displayed in an active state, and pronunciation data (“aplai”) corresponding to the search word is extracted from the specified dictionary, and the extracted pronunciation data is output from the speaker 18a (S6). Consequently, the user can learn the pronunciation of the search word by listening to the pronunciation data of the search word. Further, when the output of the pronunciation data is finished, the monochrome inversion of the “Listen” icon I1 returns to the original state and is displayed in a non-active state, and the processing moves to step S11.

Meanwhile, as shown in FIG. 9, when the user touches the “Listen/Compare” icon I2 by the finger or the touch pen 20 (S7: Yes) instead of the “Listen” icon I1 (S5: No), the “Listen/Compare” icon I2 is displayed by way of monochrome inversion and displayed in an activate state, pronunciation data (“aplai”) corresponding to the search word “apply” is extracted from the specified dictionary, and the extracted pronunciation data is output from the speaker 18a (S8).

Further, pronunciation output guidance information d2 is displayed below the explanation information d1 to encourage the user to record a pronunciation. When the user utters a pronunciation (“aplai”) toward the microphone 18b according to this pronunciation output guidance information d2, the uttered pronunciation data is registered in the user pronunciation registration area 12g (S9). Further, the registered pronunciation data is output from the speaker 18a (S10). Consequently, the user can listen to and compare correct pronunciation data included in the dictionary and pronunciation data uttered by the user. When the user finishes listening to and comparing the pronunciations, monochrome inversion of the “Listen/Compare” icon I2 returns to the original state and is displayed in a non-activate state, and the processing moves to step S11.

In addition, when the user does not listen to and compare the pronunciations in step S7 (S7: No), the processing moves to another processing (which will not be described in detail) of causing the speaker 18a to read the explanation information d1 by specifying the “Read” icon I3 or causing the speaker 18a to output pronunciation data of an example sentence by specifying the “Example Sentence” icon I4.

When pronunciation learning is finished in step S11 (S11: Yes), the processing moves to step S20 and, when the pronunciation learning is not finished (S11: No), the processing returns to S5.

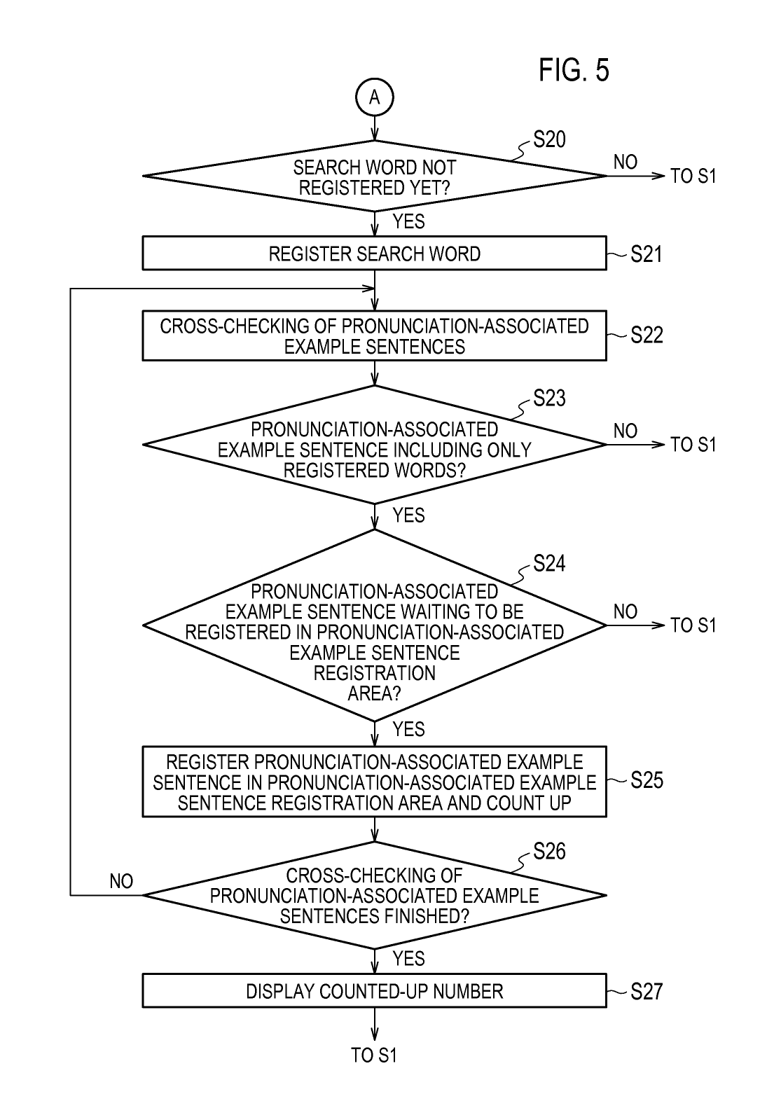

In step S20 shown in the flowchart in FIG. 5, whether or not the search word searched in step S1 has already been registered in the word registration area 12e is determined. This determination is made by cross-checking the search word searched in step S1 and words registered in the word registration area 12e. Further, in case where the search word has not been registered (S20: Yes), the search word searched in step S1 is registered in the word registration area 12e (S21), and the processing moves to step S22. Meanwhile, in case where the search word has been registered (S20: No), the processing returns to step S1.

In step S22, pronunciation-associated example sentences including the word registered in the word registration area 12e and all pronunciation-associated example sentences stored in the example sentence pronunciation storage area 12d are sequentially cross-checked. According to this cross-check processing, pronunciation-associated example sentences including only the pronunciation data of the words registered in the word registration area 12e are extracted from the example sentence pronunciation storage area 12d (S23: Yes). Further, when there are not the extracted pronunciation-associated example sentences in the pronunciation-associated example sentence registration area 12f (S24: Yes), the pronunciation-associated example sentences extracted in step S23 are registered in the pronunciation-associated example sentence registration area 12f, and counted up (S25).

Further, when cross-checking of all pronunciation-associated example sentences stored in the example sentence pronunciation storage area 12d is finished, and there is no pronunciation-associated example sentence which needs to be cross-checked in the example sentence pronunciation storage area 12d (S26: Yes), the number counted up in step S25 is displayed on the main screen 16 (S27) and the processing returns to step S1. When there are pronunciation-associated example sentences which need to be cross-checked (S26: No), the processing returns to step S22.

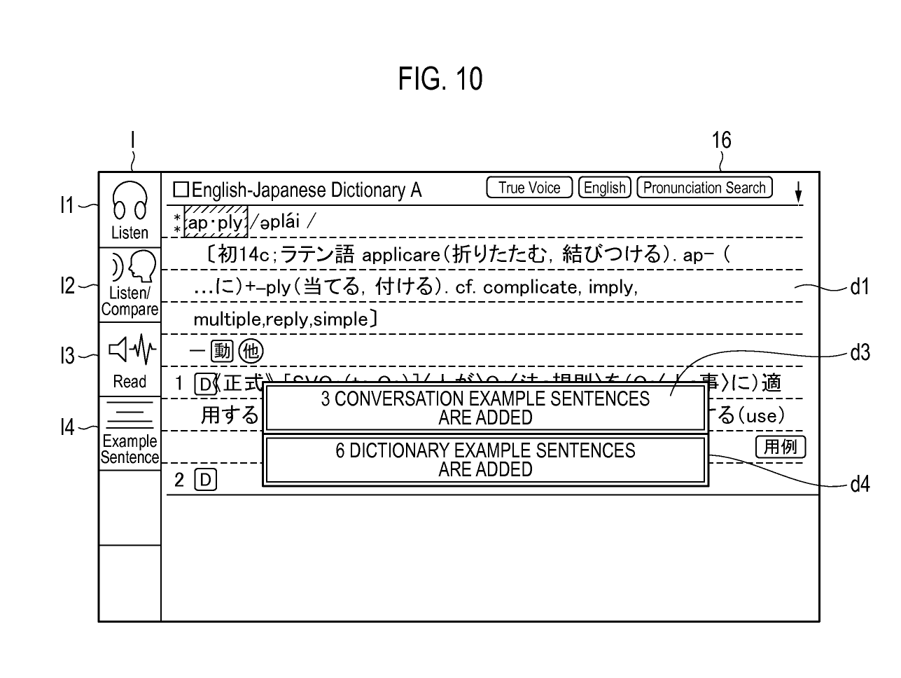

FIG. 10 is a view showing an example where counted-up number display areas d3 and d4 are displayed per source on the main screen 16 in step S27. In this example, in step S27, that three pronunciation-associated example sentences deriving from English phrases and six pronunciation-associated example sentences deriving from the dictionary are registered from the example sentence pronunciation storage area 12d to the pronunciation-associated example sentence registration area 12f is displayed on the count-up number display area d3 and the count-up number display area d4.

Meanwhile, in case where a pronunciation-associated example sentence including only the pronunciation data of the words registered in the word registration area 12e has not been extracted as a result of the cross-check performed in step S22 (S23: No), or when, even though pronunciation-associated example sentences are extracted in step S23, the extracted pronunciation-associated example sentences have already been registered in the pronunciation-associated example sentence registration area 12f (S24: No), the processing returns to step S1.

The pronunciation learning device 10 according to the present embodiment can extract pronunciation-associated example sentences including only the pronunciation data of the words registered in the word registration area 12e as described above. Consequently, the user can efficiently accumulate pronunciation-associated example sentences for which only words the user has learned are used, i.e., only pronunciation-associated example sentences which the user needs to learn.

Meanwhile, when search is not performed in the dictionary in step S1 (S1: No), the user can select whether or not to perform registered pronunciation example sentence list processing (S31 to S39).

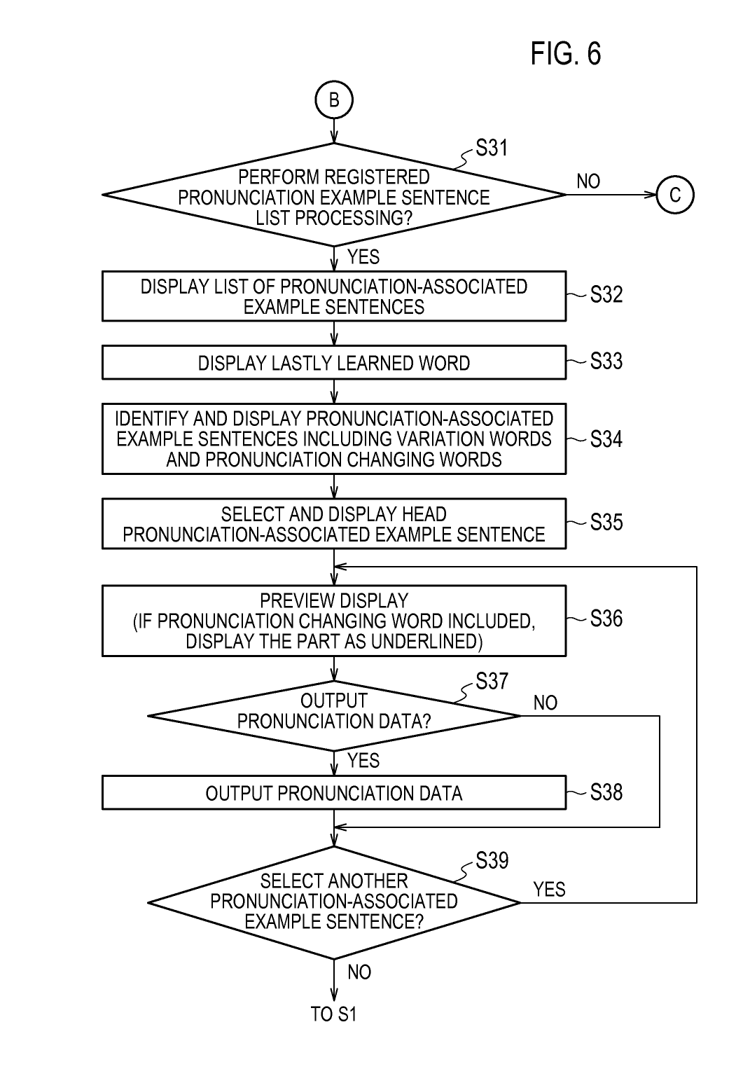

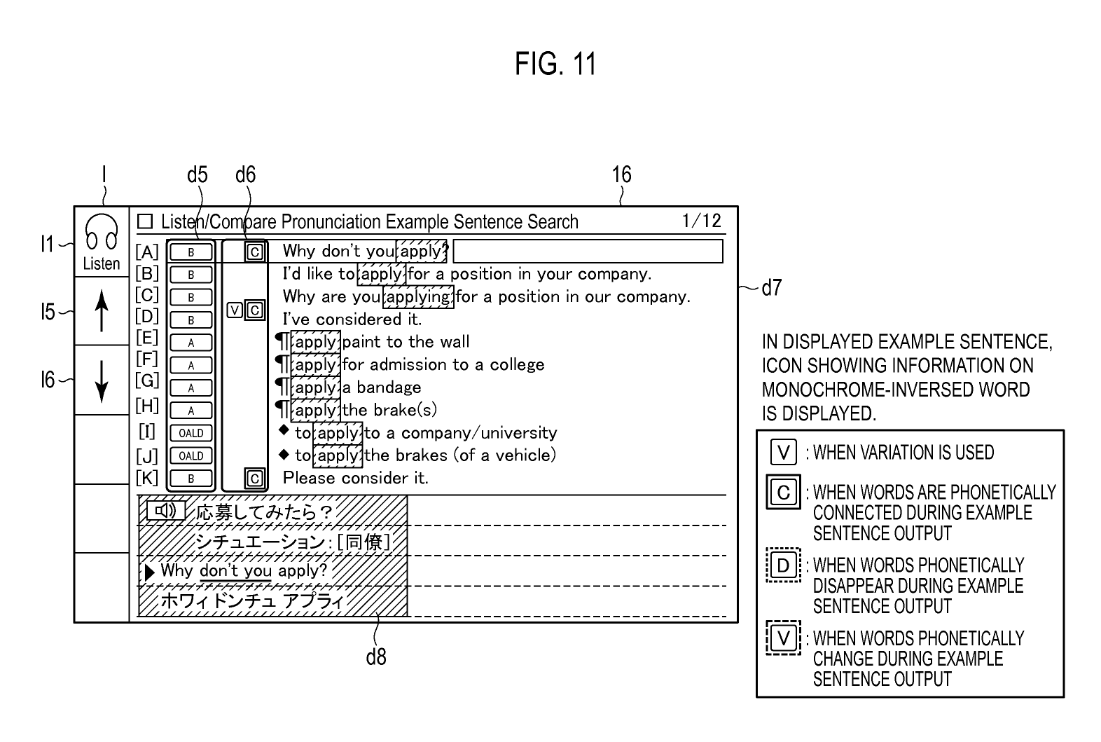

An example of the registered pronunciation example sentence list processing (S31 to S39) will be described with reference to the flowchart in FIG. 6 and the display screen example in FIG. 11.

When the registered pronunciation example sentence list processing is selected in step S31 (S31: Yes), a list of pronunciation-associated example sentences registered in the pronunciation-associated example sentence registration area 12f in step S25 is displayed from an example sentence display area d7 secured on the main screen 16 as shown in FIG. 11. Further, as the function selection icons I, a “↑” icon I5 and a “↓” icon I6 for scrolling the display screen are displayed in addition to the “Listen” icon I1 (S32).

In the example sentence display area d7, “apply” which is the lastly learned word is identified and explicitly indicated in each pronunciation-associated example sentence. Further, an abbreviated name of a source (e.g. the English-Japanese Dictionary A) of each pronunciation-associated example sentence is displayed in a source display field d5 secured on the main screen 16 (S33).

Further, an icon indicating a corresponding variation of a pronunciation-associated example sentence including a variation word and pronunciation changing words among a list of pronunciation-associated example sentences displayed in the example sentence display area d7 is displayed in a variation display field d6 secured on the main screen 16 (S34). [V] (d6V) among icons displayed in the variation display field d6 in FIG. 11 means that a variation is used (e.g. “apply” is not in an original form like “applying” or “applied”). [C] (d6C) means that there are phonetically connected words when an example sentence is vocally output. [D] (d6D) means that there are phonetically disappearing words when an example sentence is vocally output. [E] (d6E) means that there are phonetically changing words when an example sentence is vocally output. Such a variation word and pronunciation changing words are recognized by a known technique such as waveform analysis; therefore, a detailed description thereof will be omitted.

In the example sentence display area d7, a head pronunciation-associated example sentence (“Why don't you apply?” in case of FIG. 11) among a displayed list of pronunciation-associated example sentences is targeted (S35), and meanings, example sentences and a pronunciation are displayed in a preview area d8 secured below the main screen 16 (S36). In addition, the pronunciation-associated example sentence displayed in the preview area d8 includes the pronunciation changing words, the relevant portion is underlined and displayed. FIG. 11 shows an example where “don't you” including pronunciation changing words of “Why don't you apply?” which is a pronunciation-associated example sentence displayed in the preview area d8 is underlined.

When the “Listen” icon I1 is touched in this state, pronunciation data of the pronunciation-associated example sentence displayed in the preview area d8 is output from the speaker 18a (S37: Yes→S38).

Thus, even when the “Listen” icon I1 is touched and a pronunciation of an example sentence is output from the speaker 18a (S37: Yes→S38), or when the “Listen” icon I1 is not touched (S37: No), subsequent processing moves to step S39 either way.

In step S39, whether or not to select another pronunciation-associated example sentence from the pronunciation-associated example sentences displayed in the example sentence display area d7 is selected. When another pronunciation-associated example sentence is selected (S39: Yes), as shown in FIG. 11, another pronunciation-associated example sentence is specified by touching one of the pronunciation-attached example sentences displayed as the list in the example sentence display area d7 by the finger or the touch pen 20, and the processing returns to step S36. FIG. 11 shows that only the eleven pronunciation-associated example sentences indicated in [A] to [K] are displayed in the example sentence display area d7, and simply shows an example where the pronunciation-associated example sentences are displayed at a time in the example sentence display area d7. However, the number of pronunciation-associated example sentences is not limited to this. When there are pronunciation-associated example sentences which cannot be displayed at a time in the example sentence display area d7, the “↑” icon I5 or “↓” icon I6 are touched to scroll the screen, so that desired pronunciation-associated example sentences can be displayed in the example sentence display area d7.

Meanwhile, when no more pronunciation-associated example sentence is selected and the registered pronunciation example sentence list processing is finished (S39: No), the [Back/List] key 15d shown in FIG. 2 is pushed to return to dictionary search processing S1 and finish registered pronunciation example sentence list processing S31 (S40).

Meanwhile, when the registered pronunciation example sentence list processing is not selected in step S31 (S31: No), the user can select whether or not to perform the learning word list processing (S41 to S49).

As described above, the pronunciation learning device according to the present embodiment can flexibly select a pronunciation-associated example sentence which the user wants to vocally output from registered pronunciation-associated example sentences when the user learns a pronunciation of an example sentence.

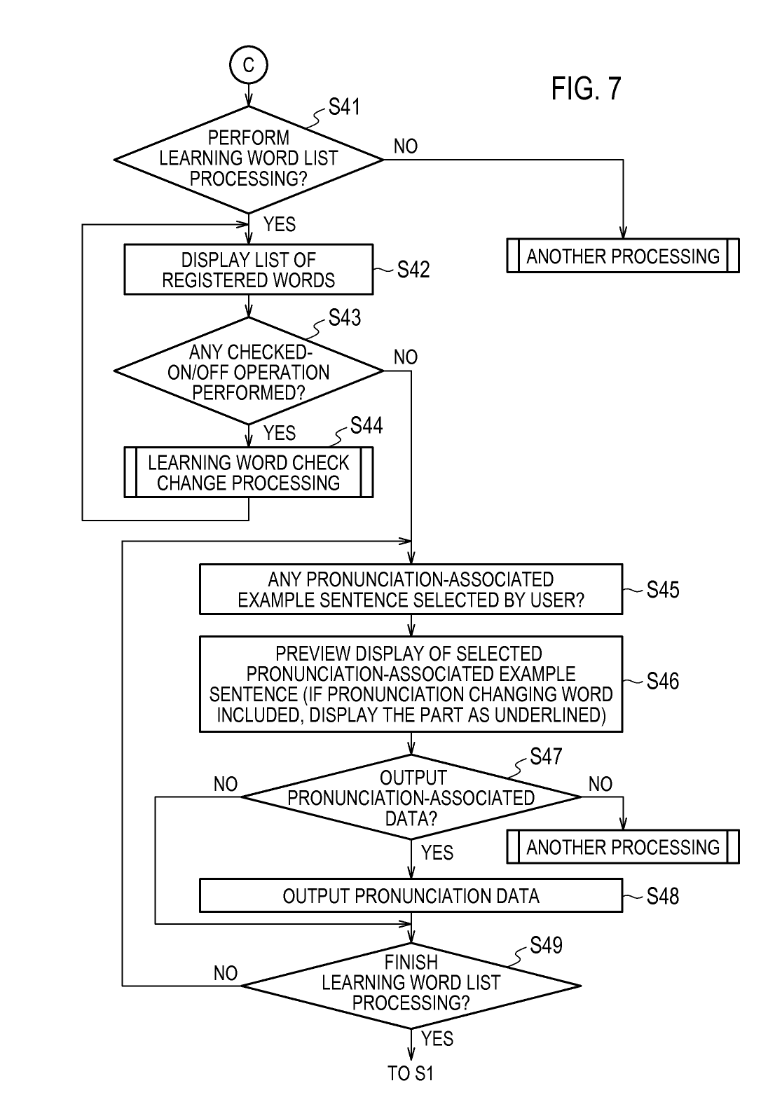

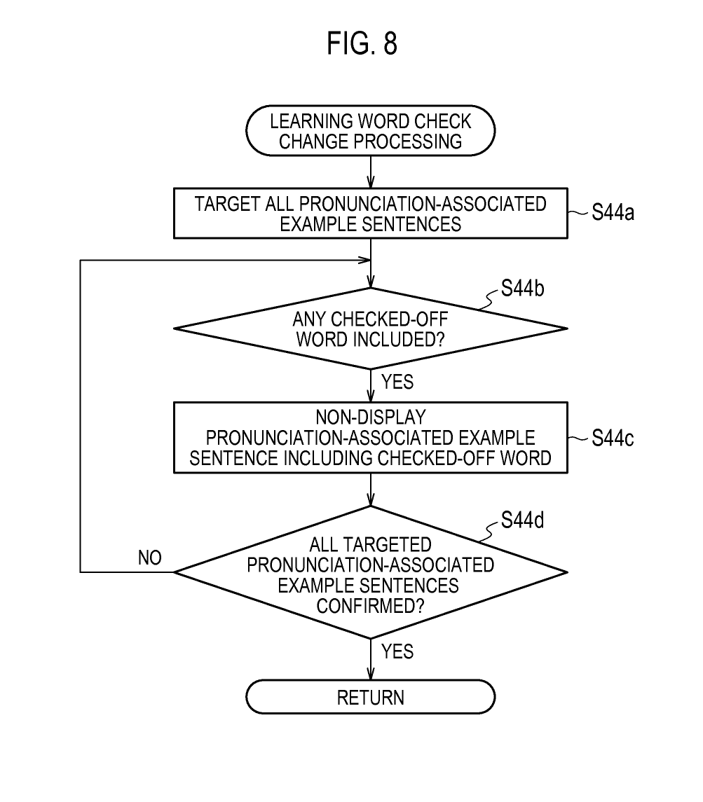

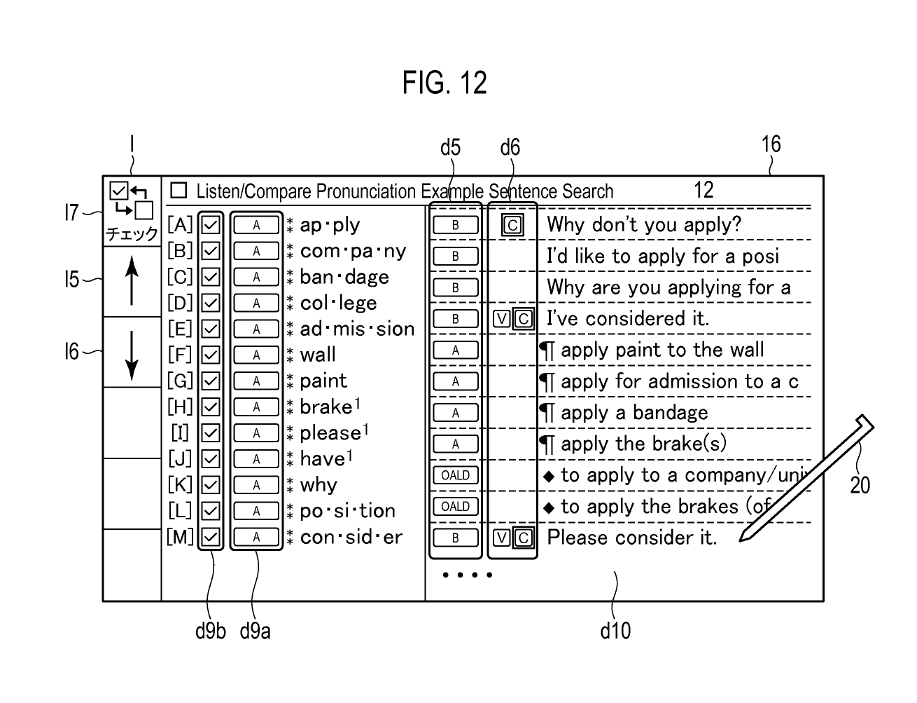

Next, an example of learning word list processing (S41 to S49) will be described with reference to the flowcharts in FIGS. 7 and 8 and the display screen examples in FIGS. 12 to 14.

When the learning word list processing is selected in step S41 (S41: Yes), as shown in FIG. 12, a list of words registered in the word registration area 12e is displayed in a word registration display area d9 secured on the main screen 16 (S42).

A display source display field d9a is further secured in the word registration display area d9, and an abbreviated name (e.g. “A” indicating English-Japanese Dictionary A) indicating a source is displayed per word in this source display field d9a.

A check field d9b is further secured in the word registration display area d9. In the learning word list processing shown in the flowcharts in FIGS. 7 and 8, the user selects an arbitrary number of words among the words registered in the word registration area 12e, and processing of searching for pronunciation-associated example sentences including only the pronunciation data of the words checked on as selection targets is performed. The check field d9b is a field which is necessary for this processing, and explicitly indicates the words checked on by the user as the selection targets from the words displayed in the word registration display area d9. In a default state, as shown in FIG. 12, “check” marks of all words registered in the word registration area 12e are applied to the check field d9b, and all words registered in the word registration area 12e are checked on and explicitly indicated as the selection targets.

Further, a pronunciation-associated example sentence display area d10 is also secured on the main screen 16, and pronunciation-associated example sentences including only the pronunciation data of the words to which “check” marks are applied to the check field d9b are displayed.

By contrast with this, the user can uncheck one of words. More specifically, when the user touches the words displayed in the word registration display area d9 by the finger or the touch pen 20 and further touches a “check” icon I7 in a state where the words are in the active state, the words are checked off, the “check” marks are removed from the check field d9b of the words and this removal is explicitly indicated.

In addition, the user can check on the words which have been checked off once and whose “check” marks in the check field d9b have been removed, by touching the words by the finger or the touch pen 20 and by touching the “check” icon I7 in a state where the words are placed in the active state, and the “check” marks are applied to the check field d9b.

In addition, the “check” icon I7, the “↑” icon I5 and the “↓” icon I6 are also secured as the function selection icons I on the main screen 16. Hence, FIG. 12 shows only an example where the number of words in [A] to [M] displayed in the word registration display area d9 is thirteen. The number of words is not limited to this. When there are words which cannot be displayed at a time in the registered word display area d9, it is possible to display other words by touching the “↑” icon I5 or the “↓” icon I6 and scrolling the screen, and perform the above check-on/off operation on the displayed words likewise. Further, it is also possible to display other pronunciation-associated example sentences of the pronunciation-associated example sentences displayed in the pronunciation-associated example sentence display area d10 by touching the “↑” icon I5 or the “↓” icon I6 and scrolling the screen.

In case where the check-on/off operation has been performed (S43: Yes), the processing moves to step S44, the check change processing is performed and then the processing returns to step S42. This check change processing will be described below with reference to the flowchart in FIG. 8.

Meanwhile, in case where a check-on/off operation has not been performed (S43: No), one of the pronunciation-associated example sentences displayed in the pronunciation-associated example sentence display area d10 is touched by the user's finger or touch pen 20 and specified (S45).

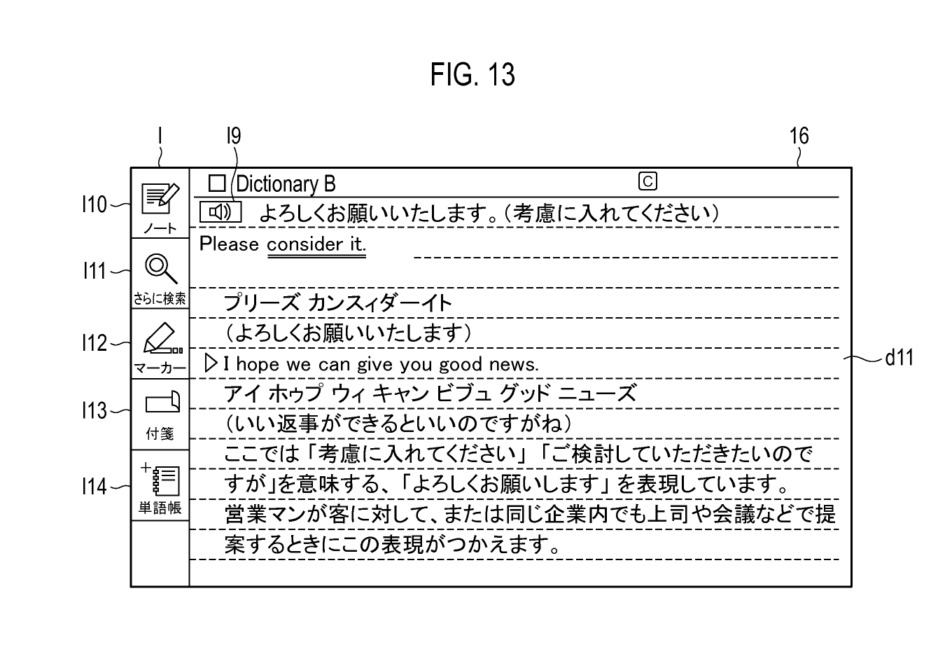

When the pronunciation-associated example sentence is selected in this way, as shown in the display screen example in FIG. 13, a preview display area d11 is secured on the main screen 16 and a translation, a pronunciation, related sentences and a usage are displayed in addition to this pronunciation-associated example sentence (S46). When this pronunciation-associated example sentence includes pronunciation changing words, the relevant portion is underlined. Further, when icons (e.g. a note icon I10, a search icon I11, a marker icon I12 and a post-it icon I13) which realize various editor functions, and a vocabulary notebook icon I14 which retrieve words registered in the word registration area 12e are optionally provided as the function selection icons I.

The preview display area d11 displays an example where a pronunciation-associated example sentence “Please consider it.” is specified in step S45, a translation of this pronunciation-associated example sentence “Yoroshikuonegaiitashimasu”, a pronunciation (plí:z k [symbol] nsíd [symbol] r ít), a related sentence (I hope we can give you good news.) and a usage are displayed in the preview display area d11 in response to this specification, and, further, pronunciation changing words (consider it) of the pronunciation-associated example sentence (Please consider it.) are underlined and displayed.

In the preview display area d11, a pronunciation output icon I9 is also provided. When the user wants to vocally output the pronunciation-associated example sentence displayed in step S46 (S47: Yes), the user touches the pronunciation output icon I9 by the finger or the touch pen 20. Thus, pronunciation data of the pronunciation-associated example sentence displayed in the preview display area d11 is output from the speaker 18a (S48), and then the processing moves to step S49.

Meanwhile, when the user does not want to vocally output the pronunciation-associated example sentence displayed in step S46 (S47), the processing directly moves to step S49.

In step S49, whether or not to continue the learning word list processing is determined. When this processing is finished (S49: Yes), the processing returns to S1 and, when this processing is continued (S49: No), the processing returns to step S45.

Meanwhile, when the user does not want the learning word list processing in step S41 (S41: No) or when the user does not specify any example sentence in step S45 (S45: No), for example, the processing moves to another processing (which will not be described in detail) of using the pronunciation learning device 10 according to the present embodiment as a normal electronic dictionary.

Next, check change processing performed in step S44 will be described with reference to the flowchart in FIG. 8.

First, all pronunciation-associated example sentences registered in the pronunciation-associated example sentence registration area 12f are targeted (S44a), and, when there are words checked off in step S43 (S44b: Yes), pronunciation-associated example sentences including the checked-off words are not displayed in the pronunciation-associated example sentence display area d10 (S44c).

The processing in steps S44b to S44c is performed per word. Hence, when there is a plurality of words subjected to the check-off operation in step S43, whether or not the processing in steps S44b to S44c has been performed on all words is determined in step S44d to repeat the processing in steps S44b to S44c on all of these words.

Further, in case where it is determined that processing in steps S44b to S44c has been performed on all words checked off in step S43 (S44d: Yes→S44e), the processing returns to step S44 shown in FIG. 7.

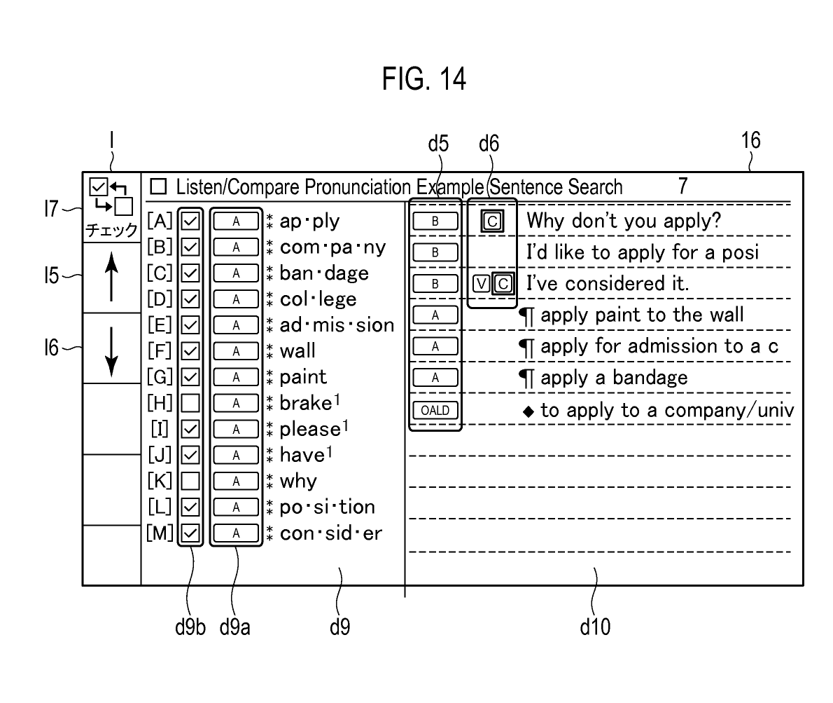

FIG. 14 shows the display example of the main screen 16 after this check change processing is performed. In step S43, as a result that a check-off operation has been performed on words such as “brake” and “why”, “check” marks are removed from check field d9b of “brake” and “why” in FIG. 14. Further, in response to this removal, in step S44c, as a result that pronunciation-associated example sentences including “brake” and “why” are not placed in a non-display state, only pronunciation-associated example sentences other than the pronunciation-associated example sentences including “brake” or “why” are left in the pronunciation-associated example sentence display area d10 as shown in FIG. 12.

Consequently, when the pronunciation learning device 10 according to the present embodiment is used, the user can flexibly select pronunciation-associated example sentences which the user wants to vocally output by performing a check-on/off operation of words.

As described above, the pronunciation learning device 10 according to the present embodiment can associate pronunciation data of words and a pronunciation data of an example sentence including these words to provide to the user. Consequently, the user can efficiently learn the pronunciation data of the words and the pronunciation data of the example sentence including these words.

In addition, a method of each processing and a database of the pronunciation learning device 10 according to the present embodiment, i.e., each method of processing (part 1 to part 5) shown in the flowcharts in FIGS. 4 to 8 and the dictionary database 12b can be stored and distributed as a program which can be executed by the computer, in the external recording medium 13 such as memory cards (e.g. a ROM card and a RAM card), magnetic disks (floppy disks and hard disks), optical disks (CD-ROMs and DVDs) and semiconductor memories. Further, a computer of an electronic device having the main screen 16 and/or, the sub screen 17 can realize processing described with reference to the flowcharts of FIGS. 4 to 8 in the present embodiment by reading to the memory 12 the program stored in this external recording medium 13 and having this read program control the operation.

Further, it is possible to transmit program data for realizing each processing on a communication network in a format of a program code. Further, it is also possible to realize each processing by installing this program data in the computer of the electronic device having the main screen 16 connected to the communication network and/or the sub screen 17 by way of communication.

### Second Embodiment

A pronunciation learning device according to the second embodiment of the present invention will be described.

In addition, only different components from those of the first embodiment will be described in the present embodiment, and overlapping description will be omitted. Hence, the same elements as those in the first embodiment will be assigned the same reference numerals below.

In the first embodiment, a case where a pronunciation learning device 10 is realized as a so-called single electronic device such as an electronic dictionary device 10D, a tablet terminal 10T, a mobile telephone, an electronic book and a mobile game has been described.

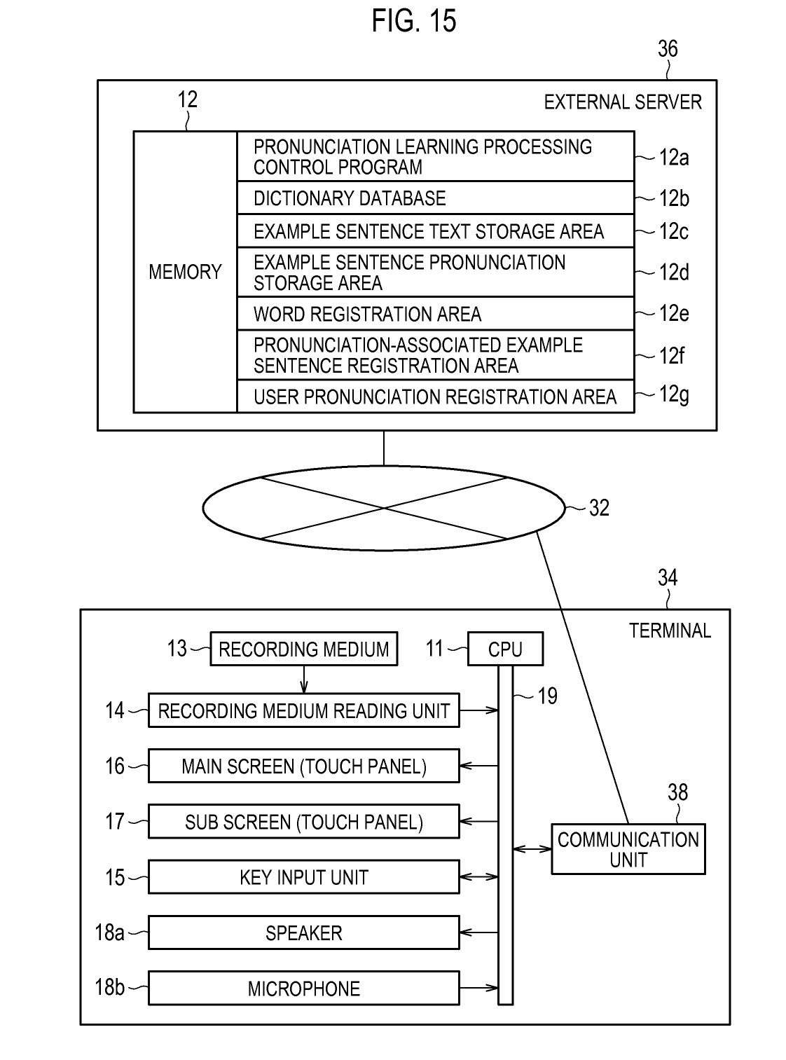

By contrast with this, as shown in FIG. 15, a pronunciation learning device 30 according to the second embodiment includes a terminal 34 and an external server 36 which are connected through a communication network 32 such as the Internet.

In addition, such a network configuration is configured by a LAN such as the Ethernet (registered trademark) or a WAN to which a plurality of LANs is connected through a public line or a dedicated line. The LAN is configured by multiple subnets connected through a router when necessary. Further, a WAN optionally includes a firewall which connects to a public line yet will not be shown and described in detail.

The terminal 34 includes a CPU 11, a recording medium reading unit 14, a key input unit 15, a main screen 16, a sub screen 17, a speaker 18a, a microphone 18b and a communication unit 38 which are connected with each other through a communication bus 19. That is, the terminal 34 is just configured to include the communication unit 38 which communicates with the communication network 32 such as the Internet in place of the memory 12 for the pronunciation learning device 10 shown in FIG. 1.

This terminal 34 is realized as a so-called single electronic device such as a personal computer, a tablet terminal, a mobile telephone, an electronic book and a mobile game machine.

Meanwhile, the external server 36 includes a memory 12 shown in FIG. 1.

Further, the terminal 34 causes the communication unit 38 to access the external server 36 through the communication network 32, activates a pronunciation learning processing control program 12a stored in the memory 12 provided in the external server 36, and performs writing/reading operations on a dictionary database 12b and various storage (registration) areas 12c to 12g under control of the pronunciation learning processing control program 12a to provide the same functions as those of the pronunciation learning device 10 according to the first embodiment to users of the terminal 34.

According to this configuration, the user can obtain an effect of the pronunciation learning device 10 according to the first embodiment by using a communication terminal which the user is used to using without purchasing a dedicated device. Consequently, it is possible to enhance user friendliness. Further, the pronunciation learning processing control program 12a and the dictionary database 12b are provided in the external server 36, so that, even when the pronunciation learning processing control program 12a is updated (upgraded) or a new dictionary is introduced, it is possible to immediately enjoy a benefit of the update and the introduction without buying a terminal or installing a new application or dictionary.

The present invention is not limited to each of these embodiments and can be variously deformed without departing from the spirit of the present invention at a stage at which the present invention is carried out. Further, each embodiment includes inventions of various stages, and various inventions can be extracted by optional combinations of a plurality of disclosed components. For example, even when some components are removed from all components described in each embodiment or some components are combined in different forms, it is possible to solve the problem described in SUMMARY. When an effect described in paragraph [0010] is obtained, a configuration obtained by removing or combining these components can be extracted as an invention.

For example, although not shown, in the second embodiment, part of the memory 12 may be optionally provided to the terminal 34 instead of the external server 36. For example, providing only the pronunciation learning processing control program 12a and the dictionary database 12b to the memory 12 of the external server 36, and providing other storage (registration) areas 12c to 12g to the memory of the terminal 34 (not shown) are understood to be part of the present invention.

What is claimed is:

1. A pronunciation learning device comprising:
an example sentence text storage unit configured to store a plurality of example sentence texts each of which includes a plurality of words;
an example sentence pronunciation storage unit configured to associate and store each of the example sentence texts stored in the example sentence text storage unit with pronunciation data as a pronunciation-associated example sentence;
a word pronunciation output unit configured to vocally output pronunciation data of a word specified by a user's operation;
a pronunciation-associated example sentence registering unit configured to extract from the example sentence pronunciation storage unit a pronunciation-associated example sentence including the pronunciation data of the word, and to register the extracted pronunciation-associated example sentence; and
an example sentence pronunciation output unit configured to read from the example sentence pronunciation storage unit the pronunciation data of any one of the pronunciation-associated example sentences registered in the pronunciation-associated example sentence registering unit, and to vocally output the read pronunciation data.

2. The pronunciation learning device according to claim 1, further comprising
a word registering unit configured to register the word corresponding to the pronunciation data vocally output by the word pronunciation output unit; and
a first example sentence display unit configured to display a list of the pronunciation-associated example sentences registered in the pronunciation-associated example sentence registering unit, in response to the registration of the word in the word registering unit.

3. The pronunciation learning device according to claim 1, further comprising:
a word registering unit configured to register the word corresponding to the pronunciation data vocally output by the word pronunciation output unit;
a word display unit configured to display a list of the words registered in the word registering unit; and
a second example sentence display unit configured to extract, from the example sentence pronunciation storage unit, pronunciation-associated example sentences including the pronunciation data of the word specified and selected by the user from the words displayed as the list by the word display unit, and to display a list of the extracted pronunciation-associated example sentences.

4. The pronunciation learning device according to claim 2, further comprising:
a word registering unit configured to register the word corresponding to the pronunciation data vocally output by the word pronunciation output unit;
a word display unit configured to display a list of the words registered in the word registering unit; and
a second example sentence display unit configured to extract, from the example sentence pronunciation storage unit, pronunciation-associated example sentences including the pronunciation data of the word specified and selected by the user from the words displayed as the list by the word display unit, and to display a list of the extracted pronunciation-associated example sentences.

5. The pronunciation learning device according to claim 1, further comprising a third example sentence display unit configured to, when there is a word wherein the pronunciation data output from the example sentence pronunciation output unit is different from the pronunciation data output from the word pronunciation output unit, display a pronunciation-associated example sentence corresponding to the word in a state where the word is identifiable among other words.

6. The pronunciation learning device according to claim 2, further comprising a third example sentence display unit configured to, there is a word wherein the pronunciation data output from the example sentence pronunciation output unit is different from the pronunciation data output from the word pronunciation output unit, display a pronunciation-associated example sentence corresponding to the word in a state where the word is identifiable among other words.

7. The pronunciation learning device according to claim 3, further comprising a third example sentence display unit configured to, there is a word wherein the pronunciation data output from the example sentence pronunciation output unit is different from the pronunciation data output from the word pronunciation output unit, display a pronunciation-associated example sentence corresponding to the word in a state where the word is identifiable among other words.

8. The pronunciation learning device according to claim 4, further comprising a third example sentence display unit configured to, there is a word wherein the pronunciation data output from the example sentence pronunciation output unit is different from the pronunciation data output from the word pronunciation output unit, display a pronunciation-associated example sentence corresponding to the word in a state where the word is identifiable among other words.

9. The pronunciation learning device according to claim 2, wherein there is a word registered in advance in the word registering unit.

10. A pronunciation learning device which outputs pronunciation data by transmitting and receiving necessary data to and from an external server configured to store pronunciation data of a word, an example sentence text including a plurality of words, and a pronunciation-associated example sentence obtained by associating the pronunciation data with the example sentence text, the pronunciation learning device comprising:
a word pronunciation output unit configured to obtain pronunciation data of a word specified by a user's operation, from the external server, and to vocally output the obtained pronunciation data;
a pronunciation-associated example sentence registering unit configured to extract from the external server a pronunciation-associated example sentence including the pronunciation data of the word, and to register the extracted pronunciation-associated example sentence in the external server; and
an example sentence pronunciation output unit configured to read from the external server the pronunciation data of any one of the pronunciation-associated example sentences registered in the external server, and to vocally output the pronunciation data.

11. A program for controlling a computer of an electronic device, the program causing the computer to function as:
an example sentence text storage unit configured to store a plurality of example sentence texts each of which includes a plurality of words;
an example sentence pronunciation storage unit configured to associate and store each of the example sentence texts stored in the example sentence text storage unit with pronunciation data as a pronunciation-associated example sentence;
a word pronunciation output unit configured to vocally output pronunciation data of a word specified by a user's operation;
a pronunciation-associated example sentence registering unit configured to extract from the example sentence pronunciation storage unit a pronunciation-associated example sentence including the pronunciation data of the word, and to register the extracted pronunciation-associated example sentence; and
an example sentence pronunciation output unit configured to read from the example sentence pronunciation storage unit the pronunciation data of any one of the pronunciation-associated example sentences registered in the pronunciation-associated example sentence registering unit, and to vocally output the pronunciation data.

12. A program for controlling a computer of an electronic device configured to output pronunciation data by transmitting and receiving necessary data to and from an external server configured to store pronunciation data of a word, an example sentence text including a plurality of words, and a pronunciation-associated example sentence obtained by associating the pronunciation data with the example sentence text, the program causing the computer to function as:
a word pronunciation output unit configured to obtain pronunciation data of a word specified by a user's operation, from the external server, and to vocally output the obtained pronunciation data;
a pronunciation-associated example sentence registering unit configured to extract from the external server a pronunciation-associated example sentence including the pronunciation data of the word, and to register the extracted pronunciation-associated example sentence in the external server; and
an example sentence pronunciation output unit configured to read from the external server the pronunciation data of any one of the pronunciation-associated example sentences registered in the external server, and to vocally output the read pronunciation data.
